(19) United States
(12) Patent Application Publication
(10) Pub. No.: US 2005/0228686 A1
(43) Pub. Date: Oct. 13, 2005

(54) Method determining filename of digital content file and apparatus for generating digital content

(75) Inventors: Tae-hun Lee, Suwon-si (KR); Hyok-sung Choi, Anyang-si (KR); Du-il Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/076,011

(22) Filed: Mar. 10, 2005

(30) Foreign Application Priority Data
Apr. 9, 2004 (KR) 10-2004-0024549

(51) Int. Cl. G06F 17/60

(52) U.S. Cl. 705/1

(57) ABSTRACT

A method of determining a filename of a digital content file generated by a CE product in accordance with a PSFS standard and an apparatus for generating a digital content file are provided. The method of determining a filename of a digital content file includes generating a first character string identifying an apparatus for generating the digital content file, generating a second character string representing a storing order of the digital content file, and determining the filename of the digital content file based on the first and second character strings. Furthermore, the second character string of the digital content file is generated by increasing character code of the second character string of a last-stored digital content file by a predetermined value. Accordingly, it is possible to overcome the limitation on the maximum number of files stored in one directory of the conventional method. In addition, it is possible to keep compatibility with the filenames in accordance with the conventional Digital Content Forum (DCF) standard.

### BACKGROUND OF THE INVENTION

This application claims the priority of Korean Patent Application No. 2004-24549, filed on Apr. 9, 2004, in the Korean Intellectual Property Office, the disclosure of which is incorporated herein in its entirety by reference.

1. Field of the Invention

Apparatuses and methods consistent with the present invention relate to digital contents, and more particularly, to a method of determining a filename of a digital content file and an apparatus for generating a digital content.

2. Description of Related Art

Recently, various digital contents including digital pictures, digital video clips, digital audios, and texts have been processed and reproduced by a personal computer. In particular, digital cameras, digital camcorders, and digital audio players for reproducing MP3 files (MPEG audio files) and WMA files (Microsoft Window Media Audio files) have been widely used. Therefore, various types of digital contents used for these apparatuses have been generated.

FIG. 1 is a view showing an example using a digital content generation apparatus.

A digital content 100 such as a digital picture generated by a digital camera and a digital video clip generated by a digital camcorder is produced or edited by a producer in a computer or media server 110. The digital content 100 is stored in an optical disk 120 such as a CD or DVD, and reproduced with a CD or DVD player 130. A user enjoys the digital content 100 displayed on a display apparatus such as a TV 132. The digital content 100 can be transmitted to a printer 140 or provided to users in an online service 142.

The aforementioned digital content 100 is handled in units of files. Conventionally, the Digital Content Forum (hereinafter referred to as DCF) standard is used as a file system for managing only the digital picture files out of the digital content files.

FIG. 2 is a block diagram showing a conventional digital content filename and directory structure.

The digital content filename and directory structure is generated in accordance with the DCF standard. As shown in FIG. 2, in the DCF standard, the digital content files are stored in an XXXSSDVC directory under a DCIM directory which is a subdirectory of a root directory. In the directory name of XXXSSDVC, “XXX” is allocated with a numeral of 000 to 999, and “SSDVC” is allocated with a charter string identifying an associated product. The digital content filename is represented in a form of DCAMXXXX.JPG. In the digital content filename, “DCAM” is allocated with a 4-digit alphabet character string identifying the associated product, and “XXXX” is allocated with a 4-digit numeral. Since the 4-digit numeral is in a range of 0000 to 9999, 10,000 digital content files can be stored in a single directory. In case of the number of digital content files exceeding 10,000, a new directory has to be created to store excess digital content files.

Since the conventional DCF standard supports only the digital picture files, a new standard, “Portable Storage File System (hereinafter, referred to as PSFS)” has been proposed and argued to support all types of digital contents such as digital pictures, digital videos, and digital audios used for multimedia consumer electronics (CE) products.

If the new PSFS standard is directly applied to filenames determined in accordance with the conventional DCF standard, there is a limitation in that only 10,000 files can be stored in a single directory. In particular, as the capacity of storage media becomes larger, the limitation on the number of stored files causes great inconvenience. In addition, in a case where the digital contents 100 are exchanged between the personal computers or media servers 110, there is a problem in that the filenames are likely to overlap or conflict with each other.

Therefore, there is a demand for a standard of determining new filenames so that digital content files can be stored in a large storage medium without limitation on the number of stored files. In addition, it is necessary that the new standard has compatibility with the conventional DCF standard.

### SUMMARY OF THE INVENTION

The present invention provides a method of determining a filename of a digital content file generated by a CE product in accordance with a PSFS standard and an apparatus for generating a digital content file.

According to an aspect of the present invention, there is provided a method of determining a filename of a digital content file, comprising: generating a first character string identifying an apparatus for generating the digital content file; generating a second character string representing a storing order of the digital content file; and determining the filename of the digital content file based on the first and second character strings, wherein the second character string of the digital content file is generated by increasing character code of the second character string of the last-stored digital content file by a predetermined value.

The second character string may comprise numerals and alphabet letters.

The determining of the filename may comprise determining the filename by allocating a character string indicating a type of the digital content file to an extension of the filename.

The digital content file may include at least one of a digital picture file, a digital video clip file, and a digital audio file. Further, the extension character string of the digital content file is uniquely determined to correspond to the type of the digital content file.

The filename determined in the generating of the first character string and the generating of the second character string may be compatible with a filename determined in accordance with a Digital Content Forum (DCF) standard.

According to another aspect of the present invention, there is provided an apparatus for generating a digital content file, comprising: a content generation unit generating the digital content file; a filename determination unit determining a filename of the digital content file based on a first character string identifying an apparatus for generating the digital content file and a second character string representing a storing order of the digital content file; and a recording control unit recording the digital content file having the determined filename in a predetermined storage medium, wherein the second character string of the digital content file is generated by increasing character code of the second character string of the last-stored digital content file by a predetermined value.

The predetermined storage medium may comprise at least one of a memory, a memory stick, an optical disk, and a hard disk.

The digital content generation apparatus may comprise at least one of a digital camera, a camcorder, an audio file player, and a multimedia file player.

### BRIEF DESCRIPTION OF THE DRAWINGS

The above and other aspects of the present invention will become more apparent by describing in detail exemplary, non-limiting embodiments thereof with reference to the attached drawings in which:

FIG. 1 is a view showing an example of a digital content generation apparatus;

FIG. 2 is a block diagram showing a conventional digital content filename and directory structure;

FIG. 3 is a flowchart showing a method of determining a filename of a digital content file according to the present invention;

FIG. 4 is a block diagram showing a digital content filename and directory structure determined by using the method of FIG. 3;

FIGS. 5a and 5b are views showing an example of a function used to perform the method of FIG. 3; and

FIG. 6 is a block diagram showing a construction of a digital content generation apparatus having a function of determining filenames according to the present invention.

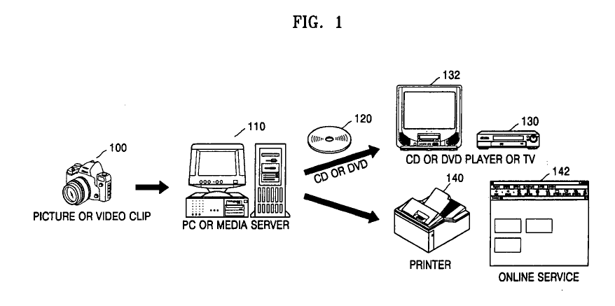

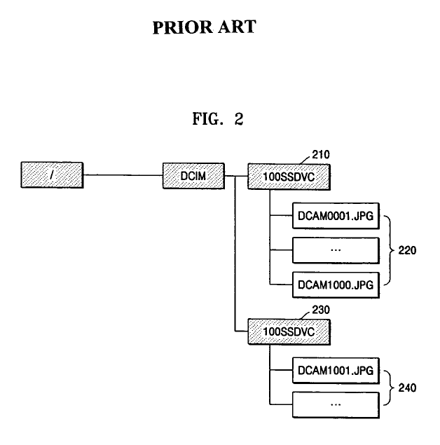

### DETAILED DESCRIPTION OF THE EXEMPLARY EMBODIMENTS

The present invention and operational advantages thereof can be fully understood by referring to the accompanying drawings and explanations thereof.

Now, exemplary embodiments of the present invention will be described with reference to the accompanying drawings to explain the present invention in detail. In the drawings, the same reference numerals indicate the same elements.

The conventional digital content forum (DCF) standard has handled only the digital picture files. The currently-adapted portable storage file system (PSFS) standard can handle digital picture files, digital video files, and digital audio files reproduced by consumer electronics (CE) products supporting multimedia. The present invention provides a method of determining a filename of a digital content file capable of increasing the number of files while keeping compatibility with a filename determined in accordance with the conventional DCF standard.

A rule for determining filenames according to the present invention is as follows:

(1) A filename is constructed with an 8-digit name character string and a 3-digit extension character string (an 8.3 rule) in accordance with the DCF standard.

(2) Front 4-digit character string of the 8-digit name character string is allocated with a character string identifying a digital content generation apparatus in accordance with the DCF standard.

(3) Rear 4-digit character string of the 8-digit name character string is allocated with numerals of 0 to 9 and alphabet letters of A to z. The numerals and alphabet letters in the rear 4-digit character string is increased by one in an order of 0 to 9 and A to z. For example, the filenames are as follows:
DCAM0001.JPG, . . . , DCAM0009.JPG, DCAM000A.JPG,
DCAM000B.JPG, . . . , DCAM000Z.JPG.

The type of a file in accordance with the aforementioned rule is referred to as a PSFS type.

In the embodiment of the present invention, the capital letters out of the alphabet letters are used. However, in order to increase the number of filenames, small letters out of the alphabet letters can be used.

Now, a method and apparatus for implementing the rule for determining filenames will be described in detail.

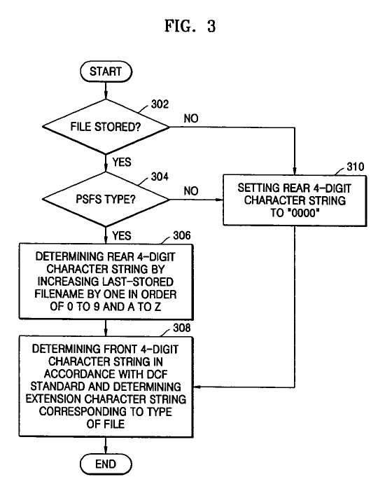

FIG. 3 is a flowchart showing a method of determining a filename of a digital content file according to the present invention.

Firstly, a digital content generation apparatus according to the present invention determines whether or not there is a newly-stored digital content file (S302). If there is a newly-stored digital content file, it is determined whether or not the type of the newly-stored digital content file is the PSFS type (S304). If the type of the newly-stored digital content file is the PSFS type, the rear 4-digit character string of the newly-stored digital content file is obtained by increasing the rear 4-digit character string of the filename of the last stored digital content file by one in the aforementioned order of 0 to 9 and A to Z (S306). The front 4-digit character string of the newly-stored is allocated with a character string identifying the digital content generation apparatus in accordance with the DCF standard. The 3-digit extension character string is determined to correspond to the type of the newly-stored digital content file (S308).

On the other hand, if there is not a newly-stored digital content file (S302) or if the type of the newly-stored digital content file is not the PSFS type (S304), the rear 4-digit character string of the newly-stored digital content file is set to “0000” (S310), and the front 4-digit character string of the newly-stored is allocated with a character string identifying the digital content generation apparatus in accordance with the DCF standard (S308).

As a result, filenames of new files can be determined without limitation on the number of files in a large storage medium. That is, 10,000 files per directory can be stored in accordance with the conventional DCF standard. However, 1,679,616 files per directory can be stored in accordance with the rule of the present invention. The maximum number of files stored in one directory in accordance with the rule of the present invention increases about 167 times the maximum number of files stored in one directory in accordance with the conventional DCF standard. In other words, in the conventional DCF standard, 10 numerals of 0 to 9 are used for the rear 4-digit character string, so that 10⁴ (=10,000) files can be stored in one directory. In the rule according to the present invention, 36 numerals and letters of 0 to 9 and A to Z are used for the rear 4-digit character string, so that 36⁴=1,67,9617 files can be stored in one directory. According to the present invention, even in case of a multi-shot application, it is possible to store 10,000 files in one directory without problems.

In addition, filenames determined in accordance with the rule according to the present invention includes numerals of 0 to 9 in the rear 4-digit character string, so that the filename can be compatible with the filename determined in accordance with the conventional DCF standard.

Moreover, in a case where a digital content file is copied to a computer, the probability of filename conflict occurring can be lowered. In addition, since the order of 0 to 9 and A to Z is the same as the order of ASCII codes, the filenames can be conveniently sorted and searched.

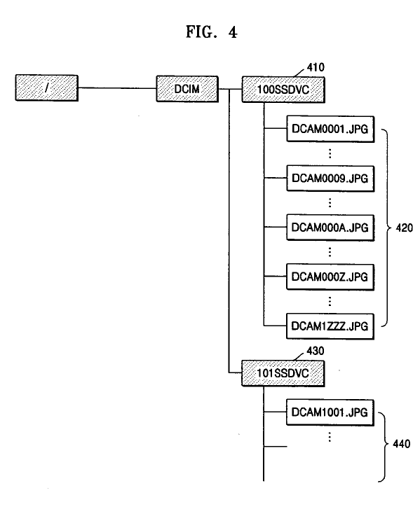

FIG. 4 is a block diagram showing a digital content filename and directory structure determined by using the method of FIG. 3.

In the method of determining filenames according to the present invention, the filename next to a filename DCAM0009.JPG is not DCAM0010.JPG but DCAM000A. JPG. Therefore, the filenames can be determined by increasing one by one from DCAM0000.JPG to DCAMZZZZ.JPG.

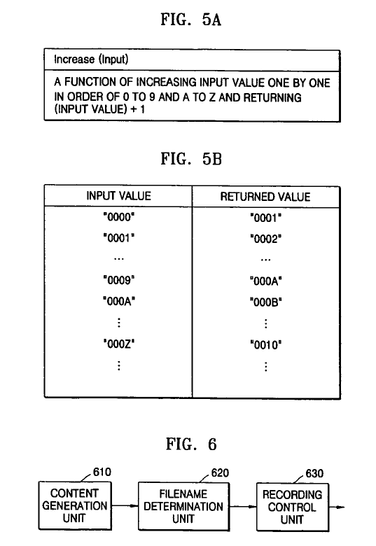

FIGS. 5A and 5B are views showing an example of a function used to perform the method of determining filenames of FIG. 3.

A function Increase(Input) according to an embodiment of the present invention is shown in FIG. 5A. The function Increase(Input) increases an input value by 1 and returns (input value)+1. Therefore, the function Increase(Input) can be used for a function of determining the rear 4-digit character string of the filename. The present invention is not limited to the function Increase(Input), but various types of functions may be used.

The result of the function Increase(Input) is shown in FIG. 5B. For example, if the input value is “0000”, the returned value is “0001”. If the input value is “0009”, the returned value is “000A”. Theoretically, if the input value is “ZZZY”, the returned value is “ZZZZ”

Now, a digital content generation apparatus will be described based on the method of determining filename according to the preset invention.

FIG. 6 is a block diagram showing a construction of a digital content generation apparatus having a function of determining filenames according to the present invention.

The digital content generation apparatus comprises a digital content generation unit 610, a filename determination unit 620, and a recording control unit 630.

The digital content generation unit 610 generates digital contents. The digital content generation unit 610 includes, for example, at least one of a digital camera generating digital picture files (JPG files), a camcorder generating digital video clip files, and an MP3 player recorder generating MP3 files.

The filename determination unit 620 determines the filename of the digital content file generated by the digital content generation unit 610. The filename is determined in accordance with the aforementioned method. The front 4-digit character string of the filenames is determined with a character string identifying the digital content generation apparatus in accordance with the DCF standard. The rear 4-digit character string of the filename is determined by increasing the last-stored filename by one by using the function Increase(Input) in the order of 0 to 9 and A to Z. The extension character string is determined to correspond to the type of the digital content file.

The recording control unit 630 records the digital content file in a storage medium (not shown), wherein the filename is determined by the filename determination unit 620. The storage medium includes, for example, a memory, a memory stick, an optical disk, or a hard disk.

The aforementioned digital content generation apparatus includes apparatuses for handling digital picture files, digital video files, and digital audio files, such as, for example, a digital camera, a camcorder, an audio file player recorder, and a multimedia file player recorder.

In a method and apparatus for determining a digital content filename according to the present invention, it is possible to increase the number of stored files while keeping compatibility with the filenames in accordance with the conventional DCF standard

Thus, it is possible to overcome a limitation on the number of 10,000 files stored in one directory in the convention method. Also, it is possible to keep compatibility with the filenames in accordance with the conventional DCF standard.

In addition, in a case where a digital content file is copied to a computer, the probability of filename conflict occurring can be lowered. In addition, the filenames can be conveniently sorted and searched.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of determining a filename of a digital content file, comprising:
generating a first character string identifying an apparatus for generating the digital content file;
generating a second character string representing a storing order of the digital content file; and
determining the filename of the digital content file based on the first and second character strings,
wherein the second character string of the digital content file is generated by increasing a character code of the second character string of a last-stored digital content file by a predetermined value.

2. The method of claim 1, wherein the second character string comprises numerals and alphabet letters.

3. The method of claim 1, wherein the determining of the filename comprises determining the filename by allocating an extension character string indicating a type of the digital content file to an extension of the filename.

4. The method of claim 3,
wherein the digital content file comprises at least one of a digital picture file, a digital video clip file, and a digital audio file, and
wherein the extension character string of the digital content file is uniquely determined to correspond to the type of the digital content file.

5. The method of claim 1, wherein a filename determined in the generating of the first character string and the generating of the second character string is compatible with a filename determined in accordance with a Digital Content Forum (DCF) standard.

6. An apparatus for generating a digital content file, comprising:
a content generation unit generating the digital content file;
a filename determination unit determining a filename of the digital content file based on a first character string identifying an apparatus for generating the digital content file and a second character string representing a storing order of the digital content file; and
a recording control unit recording the digital content file having the filename determined by said filename determination unit in a predetermined storage medium,
wherein the second character string of the digital content file is generated by increasing character code of the second character string of a last-stored digital content file by a predetermined value.

7. The apparatus of claim 6, wherein the second character string comprises numerals and alphabet letters.

8. The apparatus of claim 6, wherein the filename determination unit determines the filename by allocating an extension character string indicating a type of the digital content file to an extension of the filename.

9. The apparatus of claim 8,
wherein the digital content file comprises at least one of a digital picture file, a digital video clip file, and a digital audio file, and
wherein the extension character string of the digital content file is uniquely determined to correspond to the type of the digital content file.

10. The apparatus of claim 6, wherein a filename determined in the generating of the first character string and the generating of the second character string is compatible with a filename determined in accordance with a Digital Content Forum (DCF) standard.

11. The apparatus of claim 6, wherein the predetermined storage medium comprises at least one of a memory, a memory stick, an optical disk, and a hard disk.

12. The apparatus of claim 6, wherein the content generation unit comprises at least one of a digital camera, a camcorder, an audio file player recorder, and a multimedia file player recorder.
